(19) United States
(12) Patent Application Publication
(10) Pub. No.: US 2026/0039889 A1
(43) Pub. Date: Feb. 5, 2026

(54) Panelist-Site Metering in Conjunction with Streaming-Provider Data as a Basis to Facilitate Measurement of Live-Stream Exposure

(71) Applicant: The Nielsen Company (US), LLC, New York, NY (US)

(72) Inventors: Michelle Gelman, Reno, NV (US); David J. Kurzynski, Elgin, IL (US); Peter Campbell Doe, Ridgewood, NJ (US); Zachary Zofrea, St. Petersburg, FL (US); Denis Voytenko, Tampa, FL (US)

(21) Appl. No.: 19/282,372

(22) Filed: Jul. 28, 2025

Related U.S. Application Data
(60) Provisional application No. 63/677,699, filed on Jul. 31, 2024.

(51) Int. Cl. H04N 21/24; H04N 21/25

(52) U.S. Cl. CPC H04N 21/2407; H04N 21/251

(57) ABSTRACT

Meters at panelist sites of a panel in a market detect instances of panelist-site playout of a live-stream broadcast. Based on the detected playout, a system establishes a preliminary media-exposure measurement. The system further generates a market-wide scaling factor based on a ratio of (i) total time of streaming the broadcast in the market per streaming-provider data to (ii) an estimated total time of playing of the broadcast in the market per the detected instances of panelist-site playout; and the system generates a panel-specific scaling factor, based on a ratio of (i) a total time of streaming of the broadcast to panelist sites of the panel to (ii) an estimated total time of playout of the broadcast at panelist sites of the panel. In addition, the system applies at least the market-wide scaling factor and panel-specific scaling factor to the preliminary media-exposure measurement, to establish an adjusted media-exposure measurement.

### REFERENCE TO RELATED APPLICATION

This application claims priority to U.S. Patent Application No. 63/677,699, filed Jul. 31, 2024, the entirety of which is hereby incorporated by reference.

### SUMMARY

In an arrangement where a streaming provider (e.g., an Over The Top (OTT) streaming-media service) provides a live-stream broadcast to media players throughout a market, the streaming provider may generate data, indicating how many instances of streaming of the broadcast occurred in the market—e.g., the number of media player accounts throughout the market to which the streaming provider streamed the broadcast for playout. This streaming-provider data may then serve as a basis to determine market-wide audience exposure to the live stream, which may inform commercially valuable actions such as dynamic content modification and/or ad placement for instance.

Although this streaming-provider data may provide useful insight into the overall extent of streaming of the broadcast in the market, however, the streaming-provider data itself may lack insight into representative consumers of the live stream. For instance, the streaming-provider data itself may lack information about representative panelist sites that received the stream for playout, including information about demographic distribution of those panelist sites, among other possibilities.

The present disclosure provides a mechanism for use of panelist-site metering in conjunction with streaming-provider data as a basis to facilitate improved measurement of live-stream exposure.

In an example implementation, meters at panelist sites of a panel in a market detect instances of panelist-site playout of a live-stream broadcast and report those detected instances to a computing system, and the computing system establishes one or more preliminary measurements of media exposure based on the detected instances of panelist-site playout. Further, the computing system receives streaming-provider data indicating instances of streaming of the broadcast for playout in the market. The computing system then generates a market-wide scaling factor based on a ratio of (i) total time of streaming the broadcast in the market per the streaming-provider data to (ii) an estimated total time of playing of the broadcast in the market per the detected instances of panelist-site playout. And the computing system generates a panel-specific scaling factor, based on a ratio of (i) a total time of streaming of the broadcast to panelist sites of the panel to (ii) an estimated total time of playout of the broadcast at panelist sites of the panel. The computing system then applies at least the market-wide scaling factor and panel-specific scaling factor to the one or more preliminary media-exposure measurement, to establish an adjusted media-exposure measurement.

More particularly, an example method may include using meters at panelist sites of a panel in a market to detect instances of panelist-site playout of a live-stream broadcast, and establishing one or more preliminary media-exposure measurements based on the detected instances of panelist-site playout. Further, the method may include obtaining streaming-provider data that indicates instances of streaming of the broadcast for playout in the market.

The method may then include generating a market-wide scaling factor by at least (a) extrapolating the detected instances of panelist-site playout to a population of the market to estimate a market-wide playout total of time increments of playout of the broadcast, (b) establishing from the streaming-provider data a market-wide streaming total of time increments of streaming of the broadcast for playout, and (c) generating the market-wide scaling factor based on a ratio of the market-wide streaming total number to the market-wide playout total.

Further, the method may include generating a panel-specific scaling factor specific to the panel in the market by at least (a) determining, based on the detected instances of panelist site playout of the broadcast, a panel-specific playout total of time increments of playout of the broadcast at panelist sites of the panel, (b) filtering the streaming-provider data to establish a panel-specific streaming total of time increments of streaming of the broadcast to the panelist sites of the panel, and (c) establishing as the panel-specific scaling factor based on a ratio of the panel-specific streaming total to the panel-specific playout total.

And the method may include applying at least the market-wide scaling factor and panel-specific scaling factor to the one or more preliminary media-exposure measurements, to establish one or more adjusted media-exposure measurements. For instance, if a preliminary media-exposure measurement comprises a percentage or count of audience exposure to the broadcast, this may involve multiplying that percentage or count by both the market-wide scaling factor and the panel-specific scaling factor—or perhaps first averaging the two scaling factors and then multiplying the percentage or count by the that average, among other possibilities.

In another respect, disclosed is a media-exposure-measurement system. The system may include a plurality of meters at panelist sites of a panel in a market, with the meters being configured to detect instances of playout of media at the panelist sites. Further, the system may include at least one processor, non-transitory data storage, and program instructions stored in the non-transitory data storage and executable by the at least one processor to carry out operations based on the meters detecting instances of panelist-site playout of a live-stream broadcast. For instance, the program instructions may be executable by the at least one processor to receive, from the meters at panelist sites of the panel, reports of detected instances of panelist-site playout of a live-stream broadcast, and the instructions may further be executable by the at least one processor to establish one or more preliminary media-exposure measurements based on the detected instances of panelist-site playout and to carry out the operations noted above.

These, as well as other embodiments, aspects, advantages, and alternatives, will become apparent to those of ordinary skill in the art by reading the following detailed description, with reference where appropriate to the accompanying drawings. Further, it should be understood that the disclosure provided in this summary and elsewhere in this document is provided by way of example only and that numerous variations and other examples may be possible as well.

### BRIEF DESCRIPTION OF THE DRAWINGS

FIG. 1 is a simplified block diagram of an example arrangement in which disclosed features could be implemented.

FIG. 2 is a simplified block diagram illustrating an example market encompassing numerous media-presentation sites.

FIG. 3 is a plot illustrating how application of market-wide and panel-specific scaling factors can work cooperatively to scale media-exposure measurements that are initially established based on metering of panelist-site playout of a broadcast.

FIG. 4 is a flow chart illustrating an example method.

FIG. 5 is another flow chart illustrating an example method.

FIG. 6 is a simplified block diagram of an example media-exposure-measurement system.

### DETAILED DESCRIPTION

In order to measure the extent to which people of various demographics engage with and/or are otherwise exposed to media content (e.g., linear broadcast content, non-linear streaming media content, websites, applications, etc.), an audience-measurement company can arrange to have monitoring devices or “meters” operate in representative households or other sites in a given market. People who have their media exposure monitored may be considered “panelists,” and the places where the monitoring occurs, such as homes, offices, or other premises, may be considered “panelist sites,” with the representative panelist sites in the market cooperatively defining or being part of an audience-measurement panel. Panelists may opt into and thus consent to this monitoring.

Meters can take various forms, including for instance (i) “presentation meters,” which may be configured to monitor playout of media by media-presentation devices such as televisions, computers, tablets, phones, gaming devices, smart speakers, radios, streaming-media players, set top boxes, and audio-visual receivers, and (ii) “streaming meters” (i.e., network-traffic meters), which may be configured to monitor network traffic such as but not limited to streaming-media-related traffic and web browsing traffic.

At each of various panelist sites having a media-presentation device, for example, the audience-measurement company may arrange for a presentation meter to monitor media presentation by that device and to generate query signature data representing the presented media, on a per-minute or other per-time-increment basis. Further, the audience-measurement company may operate a back-end, cloud-based computing system, to receive and evaluate this presentation-meter-generated query signature data, in order to identify the media presented at the panelist site and thereby to establish associated media-exposure data.

By evaluating an audio line feed into the media-presentation device and/or by evaluating associated acoustic speaker output, for instance, a representative presentation meter at a panelist site may be configured to detect and extract watermarked identification codes from the audio and/or to generate digital audio fingerprint data representing component features of the audio, and to report the identification codes and/or fingerprint data, along with associated timestamps, as query signature data to the computing system for analysis. Such a presentation meter may also be configured to detect the power on or off state of the media-presentation device, so that the presentation meter can limit its media-presentation monitoring to times when the media-presentation device is on and therefore likely presenting media content being delivered to the media-presentation device.

The back-end computing system may then be configured to refer to reference signature data that maps various identification codes and/or fingerprint data to known media content items, in order to determine, based on the presentation-meter-reported identification codes and/or fingerprint data, what media content the media-presentation device was presenting at the indicated time. In particular, the computing system may be configured to search through the reference signature data in an effort to find reference signature data that matches the reported query signature data and, upon finding a match with sufficient certainty, to conclude that media content represented by the query signature data is the media associated with the matching reference signature data, and to establish associated media-presentation records for the panelist site, thus crediting the identified media content as being presented at the panelist site (e.g., as panelist-credited content).

Further, the computing system may be configured to correlate these media-presentation records with pre-stored demographics of the panelist and/or panelist site at issue, in order to establish associated media-exposure data, and the computing system may be configured to use this media-exposure data from panelist sites of the panel as a basis to establish market-wide ratings statistics that may facilitate commercial processes such as ad placement and other content delivery.

In addition, at each of various panelist sites having a local area network (LAN) or otherwise supporting packet-based network communication or the like, the audience-measurement company may arrange for a streaming meter to monitor and report to the back-end system information about network traffic at the panelist site. Without limitation, this network traffic may include streaming-media-related traffic such as streaming-media control communications and ongoing streaming-media sessions. Monitoring streaming-media-related traffic in particular may help to enhance audience measurement related to media streaming from OTT streaming-media service providers or the like.

For instance, when query signature data provided by a presentation meter at a panelist site matches reference signature data representing non-linear streaming-media content and the computing system therefore credits that streaming-media content as having been presented at the panelist site, it may also be useful for the computing system to identify the source of that streaming-media content. Including this source information as part of the media-exposure data may enhance the data and associated ratings statistics and may facilitate useful action keyed to the source. For example, knowledge that panelists (e.g., of particular demographics) have been exposed to content provided by a particular OTT service provider may support a decision to arrange for that OTT service provider to distribute particular ads and/or other content, among other possibilities.

A streaming meter may operate as a node on the LAN and be configured to monitor packet-based internet communications to and/or from a media-presentation device or other client device at the panelist site and to report associated information to the back-end system, to enable the back-end system to factor that information into its analysis and associated operations. With this information, for instance, the back-end system may be able to identify times when a client device was receiving streaming media, and the back-end system may be able to determine the source of that streaming media and correlate that information with media identification based on presentation-meter reports, which may in turn facilitate useful associated operations as discussed above.

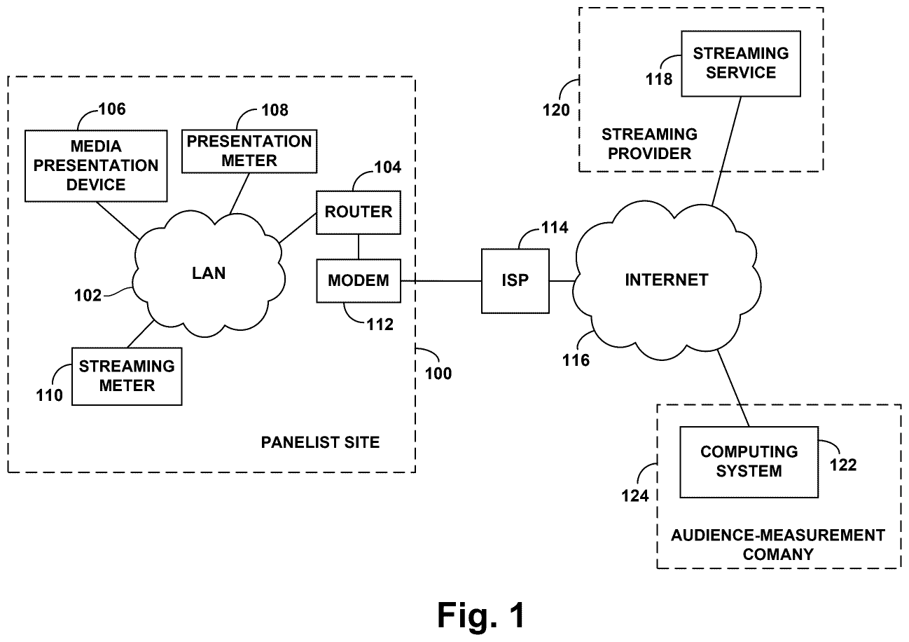

FIG. 1 is a simplified diagram of an example arrangement in relation to which various disclosed features could be implemented. It will be understood, that this and other arrangements and processes disclosed herein could take various other forms. For instance, elements and operations could be re-ordered, distributed, replicated, combined, omitted, added, or otherwise modified. Further, elements described as functional entities could be implemented as discrete or distributed components or in conjunction with other components/modules, and in any suitable combination and location. Still further, various operations described as being carried out by one or more entities could be implemented by and/or on behalf of those entities, through hardware, firmware, and/or software, such as by one or more processing units executing program instructions stored in memory, among other possibilities.

As shown in FIG. 1, the example arrangement includes at a panelist site (e.g., home, office, etc.) 100 an example packet-switched LAN 102 having a number of LAN nodes including but not limited to a router 104, a media presentation device 106, a presentation meter 108, and a streaming meter 110. These nodes may be connected to the LAN through wired (e.g., Ethernet) and/or wireless (e.g., Wi-Fi) links. Further, the meters 108, 110 could be provided as separate devices or alternatively as logic within another device.

As shown, the router 104 is connected with a modem 112, which provides connectivity with an internet service provider (ISP) 114, to facilitate communication on the internet 116. (Alternatively, the router 104 may be integrated with the modem 112.) Shown accessible through the internet 116 is then a streaming-service (e.g., an OTT server) 118, which is provided by a streaming provider 120 and is configured to stream media content such as live-stream broadcasts. And further shown accessible through the internet 116 is a back-office computing system 122, which may be operated by an example audience-measurement company 124.

With this arrangement, the streaming-service 118 may stream media to the panelist site 100 for playout by the media-presentation device 106. Further, the presentation meter 108 and streaming meter 110 may monitor media presentation and streaming at the panelist site 100 and may report this information to the computing system 122, possibly on a per-minute or other per-time-increment basis, and with reporting being largely real-time or rather as rolled up data on an hourly, daily, or other basis.

For example, the presentation meter 108 may report to the computing system 122 query signature data representing media played out by the media-presentation device 106 on a per minute or other per-time-increment basis, to enable the computing system to identify the presented media, perhaps specifically by matching reference signature data representing various streaming-media content, among other possibilities. Further, the streaming meter 110 may report to the computing system 122 streaming events representing streaming media transmission to the media-presentation device 106—such as domain events and bandwidth events representative of streaming as opposed to other types of packet-data traffic. The computing system 122 may thus receive these reports and, based on the reports, credit particular streaming-media content as being presented at the panelist site.

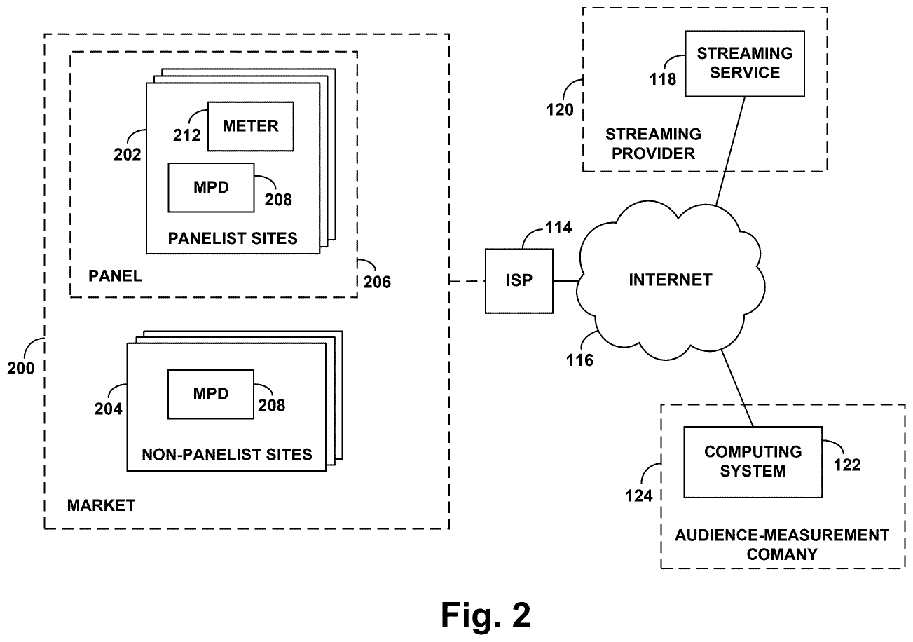

FIG. 2 is next a simplified block diagram illustrating an example market 200 encompassing numerous media-presentation sites. In particular, the market 200 is shown including multiple panelist sites 202 and multiple non-panelist sites 204, which of which may be a home, office, or other premise where media may be presented.

The panelist sites 202 in this arrangement cooperatively define a panel 206, which may be established by the audience-measurement company 124 in an effort to represent demographics of a population of media consumers throughout the market 200. In particular, panelists at the panelist sites 202 may have particular demographics, and the audience-measurement company 124 may select particular sites to be the panelist-sites (and arrange to implement meters at those sites with panelist permission) in an effort to achieve that representative distribution. The audience-measurement company 124 may structure this panel 206 in an effort to have each panelist site 202 be a sample representing some quantity of sites through the market. For instance, the audience-measurement company 124 may structure the panel to have each panelist site 202 represent on the order of 2,000 to 7,000 sites within the market, among other possibilities.

To facilitate audience measurement on per-demographic-class basis, the computing system 122 may store pre-registered identification and demographic data respectively for each panelist site 202. For instance, the computing system 122 may store a unique identification of each panelist site 202 and may store in association with that uniquely identified panelist site 202 a record of the demographics of each of one or more panelists associated with that panelist site 202.

As shown in this figure, each of the panelist sites 202 and non-panelist sites 204 may include at least one respective media-presentation device (MPD) 208, which may be configured to receive and play out media, such as but not limited to live-stream broadcasts from the streaming service 118 for instance. Further, each panelist site 202 may include at least one meter 212, which may be configured to detect instances of such playout and to report those detected instances to the computing system 122. The computing system 122 may thus receive, from meters at various panelist sites 202 of the panel 206, reports that indicate detected instances of playout of particular media at the panelist sites, and the computing system may establish media-exposure measurements based on those reports.

In an example implementation, the meters 212 at some of the panelist sites 202 of the representative panel 206 may detect and report instances of playout of a given live-stream broadcast at the panelist sites 202, possibly on a per-minute or other per-time-increment basis, and the computing system 122 may use those meter-detected instances of panelist-site playout as a basis to establish one or more preliminary media-exposure measurements—i.e., panel-based media-exposure measurements.

As an example preliminary media-exposure measurement, the computing system 122 may estimate a market-wide measure of audience exposure to the live-stream broadcast, by extrapolating from (i) the meter-detected instances of panelist-site playout of the broadcast to (ii) a market-wide population. For instance, if each panelist site 202 is considered to represent 5,000 sites in the market 200, and if the meters at 2,000 panelist sites 202 detect playout of a given minute of the broadcast, then the computing system may estimate that 10,000,000 sites throughout the market were exposed to that minute of the broadcast.

As another example preliminary media-exposure measurement, the computing system may take into account the known (e.g., registered) demographics of panelists at the panelist sites 202, to establish a demographic distribution that indicates, respectively for each of various demographic classes (i.e., demographic buckets of the distribution), an extent to which the broadcast was to exposed to panelists of that demographic class. For instance, given knowledge of the panelist demographics, and given the meter-detected instances of playout of the broadcast, the computing system may find that 60% of the people who were exposed to playout of the broadcast (e.g., viewed or listened to the broadcast, as applicable) were of the demographic class defined as female between the ages of 25 and 34, and 20% of the people who were exposed to playout of the broadcast were of the demographic class defined as male between 25 and 34.

In addition, the streaming provider 120 may itself maintain records, also on a per-minute or other per-time-increment basis, of the streaming-provider's instances of streaming the broadcast for playout in the market 200. For instance, the streaming provider 120 may have a record for each of the streaming accounts to which the streaming provider 120 streamed the broadcast, identifying each account by a unique account identifier and specifying respectively for each account start and stop times of the stream being provided to a device of the account for playout. This streaming-provider data may be referred to as first-party data or census data and may be based on actual streaming of the broadcast in the market 200 rather than on, say, estimated instances of playout of the broadcast throughout the market 200.

In an example implementation, the computing system 122 may obtain this or associated streaming-provider data from the streaming provider 120, and may use the obtained streaming-provider data in conjunction with the meter-detected instances of playout of the broadcast as basis to establish improved media-exposure measurements indicating an extent of exposure to the broadcast in the market 200.

In particular, computing system 122 may use the meter-detected instances of panelist-site playout of the broadcast and the streaming-provider-data indication of instances of streaming of the broadcast cooperatively as a basis to generate both a market-wide scaling factor and a panel-specific scaling factor, and the computing system 122 may apply at least those two generated scaling factors to the computing system's one or more preliminary media-exposure measurements as a basis to establish one or more adjusted media-exposure measurements that better represent exposure to the broadcast throughout the market 200.

In an example implementation, the computing system 122 may generate the market-wide scaling factor based on a ratio of (i) a total time of the streaming of the broadcast in the market according to the streaming-provider data to (ii) an estimated total time of playout of the broadcast in the market based on the detected instances of panelist-site playout.

As to the total time of streaming of the broadcast in the market, the streaming-provider data may specify that total, or the streaming-provider data may specify total counts of streaming of the broadcast per time increment of the broadcast, and the computing system may sum those per-time-increment counts to establish the total time of streaming the broadcast, among other possibilities. Further, as to the estimated total time of playout of the broadcast in the market, the computing system 122 may determine for each time increment of the broadcast a total count of meter-detected instances of playout of the broadcast, the computing system 122 may sum those per-minute counts to establish a total time of playout of the broadcast in the panel, and the computing system 122 may extrapolate that panel total to the market population as noted above to establish an estimated market-wide total time of playout of the broadcast.

The computing system 122 may then compute a ratio of the total time of streaming of the broadcast in the market to the estimated total time of playout of the broadcast in the market. And the computing system 122 may deem the market-wide scaling factor to be that computed ratio, or may otherwise base the market-wide scaling factor on the ratio, possibly incorporating one or more additional factors and/or operations as well.

The computing system 122 may generate the panel-specific scaling factor as a similar ratio but focused specifically on the panelist sites 202 of the panel 206 rather than on the whole market 200. To facilitate this, the computing system 122 may need to correlate the streaming accounts (to which the streaming provider 120 streamed the broadcast) with the panelist sites 202 of the panel. One way to establish this correlation is through use of a clean room, where the audience-measurement company 124 and the streaming provider 120 may provide their respective data to facilitate correlation of streaming account identifiers with panelist-site identifiers, without disclosing one party's identifier data to the other. Through use of a clean room, for instance, the computing system 122 may learn the service-provider's per-time-increment instances, counts, or other metrics of streaming of the broadcast to individual panelist sites 202 of the panel 206.

The computing system 122 may thus determine, based on the meter-detected instances of playout of the broadcast, a panel-specific total time of playout of the broadcast at panelist sites 202 of the panel 206. And based on the clean room process or other mapping between the streaming accounts and the panelist sites, the computing system 122 may effectively filter the streaming-provider data to be specific to the panelist sites 202 of the panel 206, and the computing system 122 may thus determine, based on that filtered streaming-provider data, a panel-specific total time of streaming of the broadcast to panelist sites 202 of the panel 206.

The computing system 122 may then compute a ratio of (i) the panel-specific total time of streaming of the broadcast to (ii) the panel-specific total time of playout of the broadcast. And the computing system 122 may deem the panel-specific scaling factor to be that computed ratio, or may otherwise base the panel-specific scaling factor on that ratio, possibly incorporating one or more additional factors and/or operations as well.

Applying at least the market-wide scaling factor and the panel-specific scaling factor to the one or more preliminary media-exposure measurements to establish the one or more adjusted media-exposure measurements can be particularly useful, leveraging valuable insight respectively provided by both the market-wide metrics of the streaming-provider data and also the panel-based metrics associated with the panelist sites 202.

The panelist-site metering may be keyed to the panelist sites 202 representative of particular demographics as noted above, but the market-wide extrapolation from that panelist-site metering may be a mere estimate as to the market 200 as a whole. On the other hand, the streaming-provider data may be more empirical, keyed to actual instances of streaming the broadcast throughout the market as noted above. Therefore, accounting for how the streaming provider's empirical market-wide streaming metrics compare with the panel-based estimated market-wide playout metrics may usefully give weight to the empirical streaming-provider data.

Further, the same can be said for measurement that is more panel-specific, such as measurement that is keyed to particular demographics for instance. Here too, the panelist-site metering may be keyed to the panelist sites 202 of representative demographics, but extrapolating those demographics to the market as a whole may be a mere estimate as noted above. On the other hand, the streaming-provider data as to streaming particularly to the same panelist sites 202 may be more empirical. Therefore, accounting for how the streaming-data provider's empirical panel-specific streaming metrics compare with the panel-based meter-detected playout metrics may also usefully give weight to the empirical streaming-provider data.

The present process can thus also usefully apply with respect to demographic-specific media-exposure measurement, such as where the computing system 122 establishes an initial demographic distribution as noted above. In particular, the present process can work in that scenario to improve each bucket of the distribution respectively, by applying to each bucket both the market-wide scaling factor and a panel-specific scaling factor that is specific to the demographic class of that bucket.

For each demographic bucket representing a given demographic class, for instance, the computing system 122 may identify a set of panelist sites 202 based on the panelist sites 202 matching that demographic class (e.g., having one or more panelists of that demographic class) and may then generate a demographic-specific version of the panel-specific scaling factor, based on a ratio of (i) total time increments of streaming of the broadcast to the panelist sites of the identified set, e.g., per a clean-room analysis of the streaming-provider data, to (ii) total minutes of the playout of the broadcast at the panelist sites of the identified set, per the meter-detected instances of panelist-site playout. The computing system 122 may then scale the associated demographic bucket of the demographic distribution (i.e., the bucket corresponding with that demographic class) by applying that demographic-specific panel-specific scaling factor and the market-wide scaling factor, to establish an adjusted media-exposure measure for that demographic class in particular.

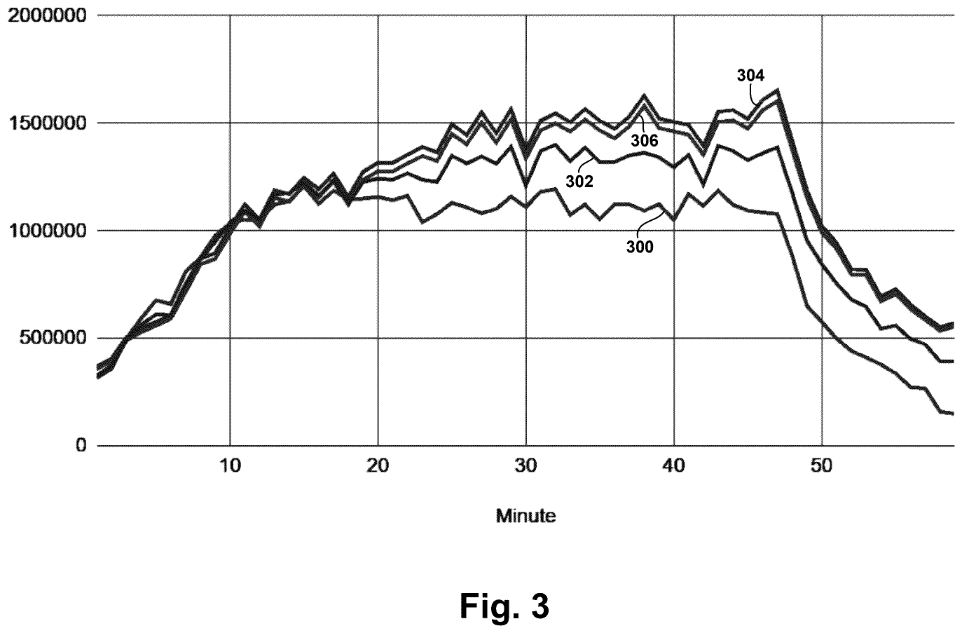

FIG. 3 illustrates how application of at least these market-wide and panel-specific scaling factors can work cooperatively to scale media-exposure measurements that are initially established based on metering of panelist-site playout of such a broadcast. FIG. 3 is a plot representing an example live-stream broadcast, with the x-axis representing minutes of the broadcast, and the y-axis representing count of minutes of streaming or playout per minute.

Curve 300 in this plot represents an estimated per-minute count of instances of playout of the broadcast, established based on extrapolating from meter-detected instances of playout at panelist sites of a panel, and may thus represent example preliminary per-minute media-exposure measurements. Curve 304 in this plot, on the other hand, represents largely empirical per-minute count of instances of streaming of the broadcast, market wide, according to example streaming-provider data. This plot may assume a reasonable correlation between market populations for these two curves. For instance, if there are actually 12 million sites in the market so that curve 304 represents counts of streaming to sites within those 12 million, the bottom curve may be based on extrapolation of the meter-detected instances of playout of the broadcast to a market of 12 million as well, among other possibilities.

Curve 302 in FIG. 3 then represents adjusted media-exposure measurements in accordance with an example implementation, here resulting in a scaling up of the curve 300 by applying at least the market-wide scaling factor and the panel-specific scaling factor.

In practice, as noted above, the computing system 122 can carry out this process with respect to each demographic-class bucket of a demographic distribution. To do this, the computing system 122 may generate a market-wide scaling factor as described above. Further, the computing system 122 may also generate a panel-specific scaling factor that is specific to a set of the panelist sites that match that demographic class. For instance, the computing system 122 may start with per-minute counts of the instances of playout of the broadcast specifically at the set of panelist sites, according to the meter-detected instances of playout at those sites panelist, and may thus represent example preliminary per-minute media-exposure measurements specific to that demographic class. Further, the computing system 122 may ascertain largely empirical per-minute counts of instances of streaming of the broadcast to the same set of panelist sites, e.g., per a clean room analysis as noted above.

The computing system may then compute the demographic-specific panel-specific scaling factor based on a ratio of (i) a total of the per-minute counts of streaming to the total of per-minute counts of playout of the broadcast to those panelist sites to (ii) a total of the per-minute counts of playout at those panelist sites. And the computing system 122 may establish adjusted media-exposure measurements in accordance with an example implementation, which may result in scaling up the per-minutes counts of playout of the broadcast by applying at least the market-wide scaling factor and the demographic-specific panel-specific scaling factor.

In an example implementation, the computing system 122 may clean the streaming-provider data before generating the market-wide scaling factor and the panel-specific scaling factor, in an effort to account for situations where the streaming-provider data is incongruous with the with the preliminary media-exposure measurements, so as to facilitate a more fair comparison of the panel-based metrics and the streaming-provider metrics. As a result, the streaming-provider data that may factor into the computing system's generation of the market-wide scaling factor and the panel-specific scaling factor may be scaled down from curve 302, to be a scaled-down set of streaming-provider data 306 as shown in FIG. 3.

As one example, if there are particular types of sites that the panel 206 does not represent—such as dormitories and military barracks in some examples—and if the streaming-provider data may include instances of streaming to such sites, the computing system 122 may scale down the streaming-provider data by an extent based on what portion of the market consists of those types of sites. For instance, if 2% of sites in the market are of such a type, the computing system 122 may reduce the streaming-provider data by 2%.

As another example, there may be continuous-stream scenarios where the live-stream broadcast continues to be streamed to a given site for playout but where a media-presentation device at the site does not play out the media, e.g., where a streaming-media player receives the stream but where a television connected to that player is currently powered off. Those scenarios create an incongruity, as the streaming-provider data would indicate instances of streaming of the broadcast in situations where meters would not detect playout of the stream. To account for this, the computing system 122 may scale down the streaming-provider data by an extent based on what portion streaming-provider-data-indicated instances of streaming of the broadcast were a result of continuous play, i.e., were streamed continuously but not played out.

It may not be reasonably practical for the computing system 122 to determine specifically what portion of the instances of streaming were a result of continuous play. Therefore, the computing system 122 may instead apply a deduction factor that is based on the extent to which streaming media playout at panelist sites 202 tend to be a result of continuous play. To establish this factor, the computing system 122 may identify in the panel 206 devices that are continuous-play capable (such as dedicated streaming-media players) and devices that are not continuous-play capable (such as smart televisions) and, based on meter reports, may compute a ratio of (i) average minutes of streaming media received for playout by the continuous-play-capable devices to (ii) average minutes of streaming media received for playout by the continuous-play-incapable devices. The computing system 122 may then scale down the streaming-provider data by that ratio.

The present process may be carried out for a given live-stream broadcast. Further, this broadcast may itself be a portion of a larger broadcast. For instance, for a live-stream of a sports game, there may be a pre-game broadcast, a game broadcast, and a post-game broadcast, or those broadcasts cooperatively define a single broadcast. Still further, the disclosed principles may apply as well with respect to other types of broadcasts or streams that may be exposed to multiple audience members in a market or other scenario.

In some implementations, the process may be carried out with respect to the entire duration of the broadcast at issue. For instance, the market-wide scaling factor and panel-specific scaling factor may be generated based on panelist-site metering and streaming-provider data over the course of the full broadcast, and those scaling factors may be applied to establish media-exposure measurements over the course of the full broadcast. Alternatively, the process may be carried out for each of a plurality of time windows of the broadcast. For instance, the broadcast may be divided into 15-minute windows, and the process may be carried out respectively for each 15-minute window, generating the market-wide scaling factor and panel-specific scaling factor based on panelist-site metering and streaming-provider data over the course of that window, and applying those scaling factors to establish media-exposure measurements over the course of that window. Other arrangements are possible as well.

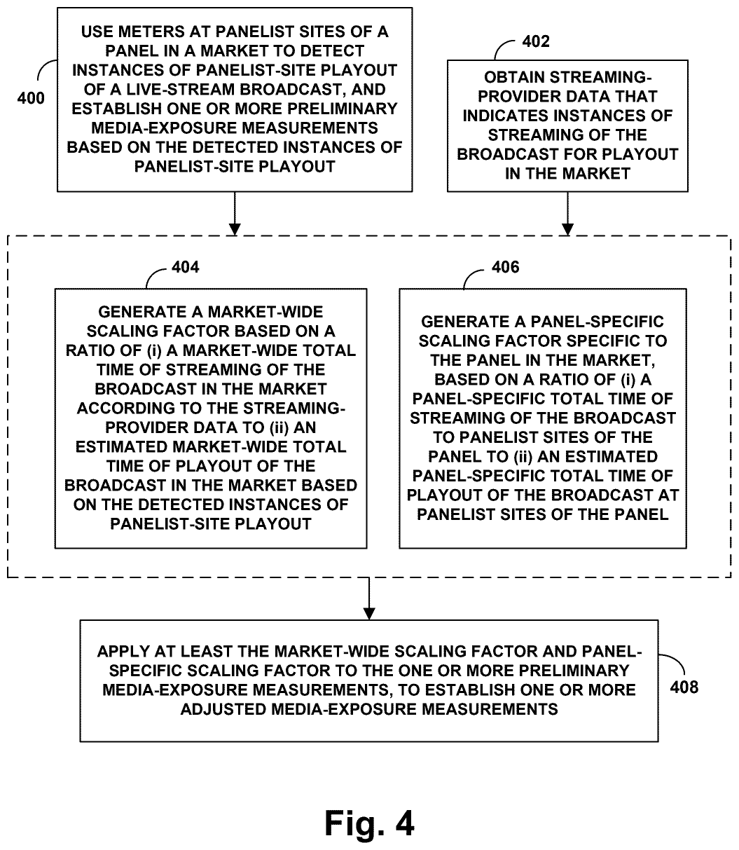

FIG. 4 is a flow chart illustrating an example method for use of metering as a basis to measure media exposure. As shown in FIG. 4, at block 400, the example method includes using meters at panelist sites of a panel in a market to detect instances of panelist-site playout of a live-stream broadcast, and establishing one or more preliminary media-exposure measurements based on the detected instances of panelist-site playout. Further, at block 402, the method includes obtaining streaming-provider data that indicates instances of streaming of the broadcast for playout in the market.

At block 404 the method then includes generating a market-wide scaling factor based on a ratio of (i) a market-wide total time of streaming of the broadcast in the market according to the streaming-provider data to (ii) an estimated market-wide total time of playout of the broadcast in the market based on the detected instances of panelist-site playout. And at block 406, the method includes generating a panel-specific scaling factor specific to the panel in the market, based on a ratio of (i) a panel-specific total time of streaming of the broadcast to panelist sites of the panel to (ii) an estimated panel-specific total time of playout of the broadcast at panelist sites of the panel. Further, at block 408, the method includes applying at least the market-wide scaling factor and panel-specific scaling factor to the one or more preliminary media-exposure measurements, to establish one or more adjusted media-exposure measurements.

In line with the discussion above, the one or more preliminary media-exposure measurements could include a demographic-specific preliminary media-exposure measurement specific to a demographic class. For instance, the method can include establishing a preliminary demographic distribution of exposure to the broadcast, with the demographic class being a bucket of the demographic distribution. In some implementations, the panel-specific scaling factor may then be a demographic-specific panel-specific scaling factor specific to the demographic class, and the act of applying at least the market-wide scaling factor and the demographic-specific panel-specific scaling factor to the demographic-specific preliminary media-exposure measurement may establish an adjusted demographic-specific media-exposure measurement specific to that demographic class.

Further, as noted above, this method can be carried out over the full duration of a given broadcast and/or for each of a plurality of time windows of the broadcast.

In addition, as discussed above, the method may additionally involve, before generating the market-wide scaling factor and the panel-specific scaling factor, scaling down the streaming-provider data based on incongruity of the streaming-provider with the one or more preliminary media-exposure measurements. For instance, this may involve excluding from the streaming-provider data one or more instances of streaming of the broadcast based on each instance of the one or more instances being to a location that is of a type that is not represented by the panel and/or scaling down the streaming-provider data based on an estimate of what portion of the instances of streaming of the broadcast were a result of continuous play, among other possibilities.

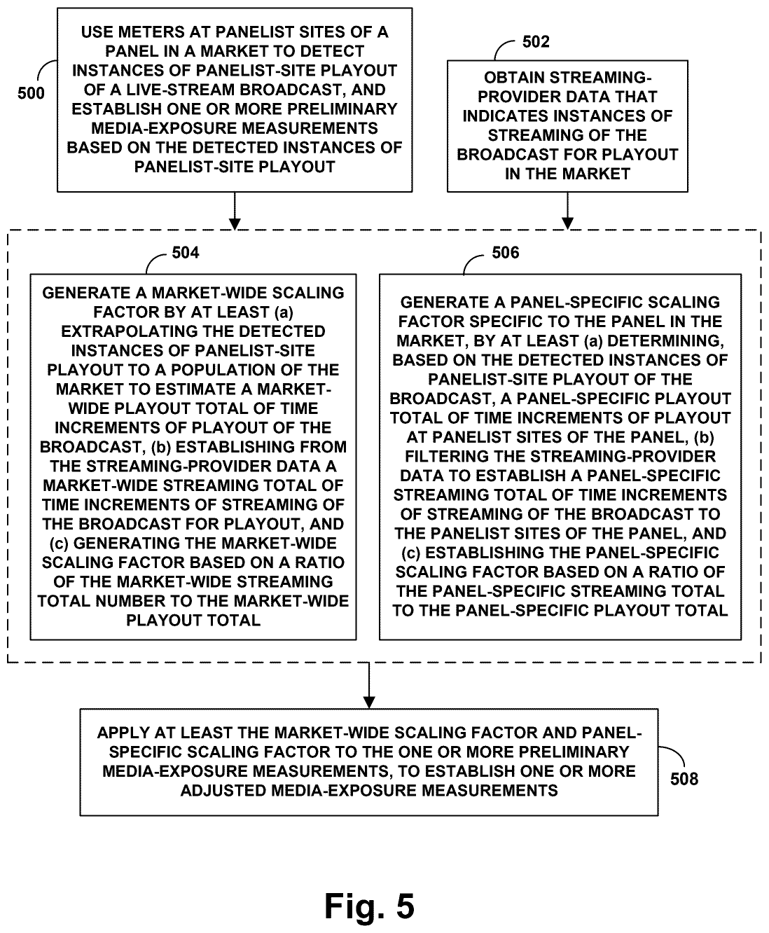

FIG. 5 is another flow chart illustrating an example method for use of metering as a basis to measure media exposure. As shown in FIG. 5, at block 500, the method includes using meters at panelist sites of a panel in a market to detect instances of panelist-site playout of a live-stream broadcast, and establishing one or more preliminary media-exposure measurements based on the detected instances of panelist-site playout. Further, at block 502, the method includes obtaining streaming-provider data that indicates instances of streaming of the broadcast for playout in the market.

At block 504, the method then includes generating a market-wide scaling factor by at least (a) extrapolating the detected instances of panelist-site playout to a population of the market to estimate a market-wide playout total of time increments of playout of the broadcast, (b) establishing from the streaming-provider data a market-wide streaming total of time increments of streaming of the broadcast for playout, and (c) generating the market-wide scaling factor based on a ratio of the market-wide streaming total number to the market-wide playout total. And at block 506, the method includes generating a panel-specific scaling factor specific to the panel in the market, by at least (a) determining, based on the detected instances of panelist-site playout of the broadcast, a panel-specific playout total of time increments of playout at panelist sites of the panel, (b) filtering the streaming-provider data to establish a panel-specific streaming total of time increments of streaming of the broadcast to the panelist sites of the panel, and (c) establishing the panel-specific scaling factor based on a ratio of the panel-specific streaming total to the panel-specific playout total. At block 508, the method then includes applying at least the market-wide scaling factor and panel-specific scaling factor to the one or more preliminary media-exposure measurements, to establish one or more adjusted media-exposure measurements.

In line with the discussion above, the time increments in this method may be minutes. Alternatively, the time increments may take other forms. Further, various other aspects disclosed herein can be carried out in this context, and vice versa.

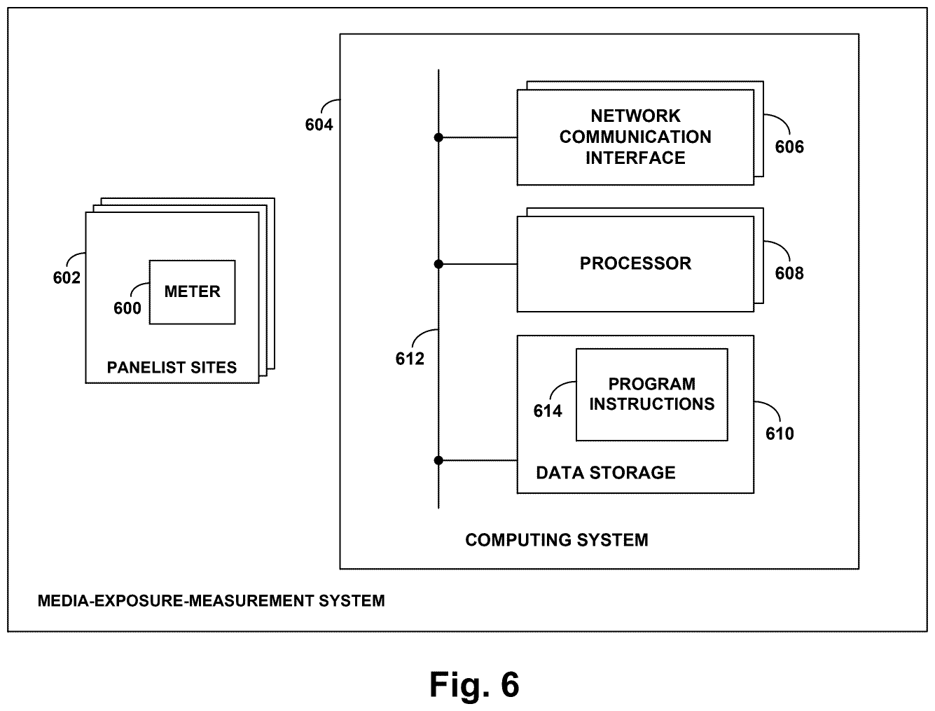

FIG. 6 is next a simplified block diagram illustrating components of an media-exposure-measurement system. As shown, this media-exposure-measurement system includes a plurality of meters 600 at panelist sites 602 of a panel in a market, the meters 600 being configured to detect instances of playout of media at the panelist sites 602. Further, the media-exposure-measurement system includes a computing system 604, shown including at least one network communication interface 606, at least one processor 608, and non-transitory data storage 610, which may be integrated together or communicatively linked by a system bus, network, or other connection mechanism 612.

The at least one network communication interface 606 may comprise one or more interfaces facilitating communication with other devices, systems, and networks, such as with the meters 600. For instance, the at least one network communication interface 606 may comprise a wired and/or wireless Ethernet interface along with one or more associated drivers.

The at least one processor 608 may comprise one or more general purpose processors (e.g., microprocessors) and/or one or more specialized processors (e.g., digital signal processors (DSPs), graphics processing units (GPUs), neural processing units (NPUs), etc.) And the non-transitory data storage 610 may comprise one or more volatile and/or non-volatile storage components (e.g., flash, optical, magnetic, read only memory (ROM), random access memory (RAM) (e.g., dynamic RAM (DRAM), static RAM (SRAM), or double data rate RAM (DDRAM)), electronically programmable read only memory (EPROM), and/or electronically erasable programmable read only memory (EEPROM), etc.), which may be integrated in whole or in part with the processor 608 or may be provided separately.

As further shown, the non-transitory data storage 610 may store (e.g., hold or embody) program instructions 614. These program instructions may be executable by the processor 608 to cause the device to carry out various operations based on the meters detecting instances of panelist-site playout of a live-stream broadcast.

In line with the discussion above, these operations may include receiving, from the meters at panelist sites of the panel, reports of detected instances of panelist-site playout of a live-stream broadcast, and establishing one or more preliminary media-exposure measurements based on the detected instances of panelist-site playout. Further, the operations may include obtaining streaming-provider data that indicates instances of streaming of the broadcast for playout in the market.

In addition, the operations may include generating a market-wide scaling factor based on a ratio of (i) a market-wide total time of streaming of the broadcast in the market according to the streaming-provider data to (ii) an estimated market-wide total time of playout of the broadcast in the market based on the detected instances of panelist-site playout. And the operations may include generating a panel-specific scaling factor specific to the panel in the market, based on a ratio of (i) a panel-specific total time of streaming of the broadcast to panelist sites of the panel to (ii) an estimated panel-specific total time of playout of the broadcast at panelist sites of the panel. Further, the operations may include applying at least the market-wide scaling factor and panel-specific scaling factor to the one or more preliminary media-exposure measurements, to establish one or more adjusted media-exposure measurements.

Various other aspects disclosed herein can be carried out in this context, and vice versa.

The present disclosure also contemplates, possibly separate from the other components noted above, non-transitory data storage (e.g., one or more non-transitory computer-readable medium components (e.g., flash, optical, magnetic, ROM, RAM) (e.g., DRAM, SRAM, or DDRAM), EPROM, and/or EEPROM, and/or other computer-readable media, etc.)) holding program instructions executable by at least one processor of a device to cause a computing system to carry out various operations described herein.

Further, the present disclosure contemplates a computer program comprising a set of program instructions executable by at least one processor of a computing system to carry out (e.g., to cause the computing system to carry out) various operations described herein. In an example implementation, the computer program could further be stored in non-transitory data storage such as that noted above, among other possibilities.

Exemplary embodiments have been described above. Those skilled in the art will understand, however, that changes and modifications may be made to these embodiments without departing from the true scope and spirit of the invention.

What is claimed is:

1. A method for use of metering as a basis to measure media exposure, the method comprising:
using meters at panelist sites of a panel in a market to detect instances of panelist-site playout of a live-stream broadcast, and establishing one or more preliminary media-exposure measurements based on the detected instances of panelist-site playout;
obtaining streaming-provider data that indicates instances of streaming of the broadcast for playout in the market;
generating a market-wide scaling factor based on a ratio of (i) a market-wide total time of streaming of the broadcast in the market according to the streaming-provider data to (ii) an estimated market-wide total time of playout of the broadcast in the market based on the detected instances of panelist-site playout;
generating a panel-specific scaling factor specific to the panel in the market, based on a ratio of (i) a panel-specific total time of streaming of the broadcast to panelist sites of the panel to (ii) an estimated panel-specific total time of playout of the broadcast at panelist sites of the panel; and
applying at least the market-wide scaling factor and panel-specific scaling factor to the one or more preliminary media-exposure measurements, to establish one or more adjusted media-exposure measurements.

2. The method of claim 1,
wherein the one or more preliminary media-exposure measurements comprises a demographic-specific preliminary media-exposure measurement specific to a demographic class,
wherein the panel-specific scaling factor is a demographic-specific panel-specific scaling factor specific to the demographic class, and
wherein applying at least the market-wide scaling factor and the demographic-specific panel-specific scaling factor to the demographic-specific preliminary media-exposure measurement establishes an adjusted demographic-specific media-exposure measurement specific to the demographic class.

3. The method of claim 2, further comprising establishing a preliminary demographic distribution of exposure to the broadcast, wherein the demographic class is a bucket of the demographic distribution.

4. The method of claim 1, further comprising carrying out the method respectively for each of a plurality of time windows of the broadcast.

5. The method of claim 1, further comprising, before generating the market-wide scaling factor and the panel-specific scaling factor, scaling down the streaming-provider data based on incongruity of the streaming-provider with the one or more preliminary media-exposure measurements.

6. The method of claim 5, wherein scaling down the streaming-provider data comprises excluding from the streaming-provider data one or more instances of streaming of the broadcast based on each instance of the one or more instances being to a location that is of a type that is not represented by the panel.

7. The method of claim 5, wherein scaling down the streaming-provider data comprises scaling down the streaming-provider data based on an estimate of what portion of the instances of streaming of the broadcast were a result of continuous play.

8. A method for use of metering as a basis to measure media exposure, the method comprising:
using meters at panelist sites of a panel in a market to detect instances of panelist-site playout of a live-stream broadcast, and establishing one or more preliminary media-exposure measurements based on the detected instances of panelist-site playout;
obtaining streaming-provider data that indicates instances of streaming of the broadcast for playout in the market;
generating a market-wide scaling factor by at least (a) extrapolating the detected instances of panelist-site playout to a population of the market to estimate a market-wide playout total of time increments of playout of the broadcast, (b) establishing from the streaming-provider data a market-wide streaming total of time increments of streaming of the broadcast for playout, and (c) generating the market-wide scaling factor based on a ratio of the market-wide streaming total number to the market-wide playout total;
generating a panel-specific scaling factor specific to the panel in the market, by at least (a) determining, based on the detected instances of panelist-site playout of the broadcast, a panel-specific playout total of time increments of playout at panelist sites of the panel, (b) filtering the streaming-provider data to establish a panel-specific streaming total of time increments of streaming of the broadcast to the panelist sites of the panel, and (c) establishing the panel-specific scaling factor based on a ratio of the panel-specific streaming total to the panel-specific playout total; and
applying at least the market-wide scaling factor and panel-specific scaling factor to the one or more preliminary media-exposure measurements, to establish one or more adjusted media-exposure measurements.

9. The method of claim 8,
wherein the one or more preliminary media-exposure measurements comprises a demographic-specific preliminary media-exposure measurement specific to a demographic class,
wherein the panel-specific scaling factor is a demographic-specific panel-specific scaling factor specific to the demographic class, and
wherein applying at least the market-wide scaling factor and the demographic-specific panel-specific scaling factor to the demographic-specific preliminary media-exposure measurement establishes an adjusted demographic-specific media-exposure measurement specific to the demographic class.

10. The method of claim 9, further comprising establishing a preliminary demographic distribution of exposure to the broadcast, wherein the demographic class is a bucket of the demographic distribution.

11. The method of claim 8, further comprising carrying out the method respectively for each of a plurality of time windows of the broadcast.

12. The method of claim 8, further comprising, before generating the market-wide scaling factor and the panel-specific scaling factor, scaling down the streaming-provider data based on incongruity with the one or more preliminary media-exposure measurements.

13. The method of claim 12, wherein scaling down the streaming-provider data comprises excluding from the streaming provider data one or more instances of streaming based on each instance of the one or more instances being to a location of a type that is not represented by the panelist sites.

14. The method of claim 12, wherein scaling down the streaming-provider data comprises scaling down the streaming-provider data based on an estimate of what portion of the instances of streaming of the broadcast were a result of continuous play.

15. A media-exposure-measurement system comprising:
a plurality of meters at panelist sites of a panel in a market, wherein the meters are configured to detect instances of playout of media at the panelist sites;
at least one processor;
non-transitory data storage; and
program instructions stored in the non-transitory data storage and executable by the at least one processor to carry out operations based on the meters detecting instances of panelist-site playout of a live-stream broadcast:
receiving, from the meters at panelist sites of the panel, reports of detected instances of panelist-site playout of a live-stream broadcast, and establishing one or more preliminary media-exposure measurements based on the detected instances of panelist-site playout,
obtaining streaming-provider data that indicates instances of streaming of the broadcast for playout in the market,
generating a market-wide scaling factor based on a ratio of (i) a market-wide total time of streaming of the broadcast in the market according to the streaming-provider data to (ii) an estimated market-wide total time of playout of the broadcast in the market based on the detected instances of panelist-site playout,
generating a panel-specific scaling factor specific to the panel in the market, based on a ratio of (i) a panel-specific total time of streaming of the broadcast to panelist sites of the panel to (ii) an estimated panel-specific total time of playout of the broadcast at panelist sites of the panel, and
applying at least the market-wide scaling factor and panel-specific scaling factor to the one or more preliminary media-exposure measurements, to establish one or more adjusted media-exposure measurements.

16. The media-exposure measurement system of claim 15,
wherein the one or more preliminary media-exposure measurements comprises a demographic-specific preliminary media-exposure measurement specific to a demographic class,
wherein the panel-specific scaling factor is a demographic-specific panel-specific scaling factor specific to the demographic class, and
wherein applying at least the market-wide scaling factor and the demographic-specific panel-specific scaling factor to the demographic-specific preliminary media-exposure measurement establishes an adjusted demographic-specific media-exposure measurement specific to the demographic class.

17. The media-exposure measurement system of claim 16, wherein the operations are executable respectively for each of a plurality of time windows of the broadcast.

18. The media-exposure measurement system of claim 16, wherein the operations additionally include, before generating the market-wide scaling factor and the panel-specific scaling factor, scaling down the streaming-provider data based on incongruity with the one or more preliminary media-exposure measurements.

19. The media-exposure measurement system of claim 18, wherein scaling down the streaming-provider data comprises excluding from the streaming provider data one or more instances of streaming based on each instance of the one or more instances being to a location of a type that is not represented by the panelist sites.

20. The media-exposure measurement system of claim 18, wherein scaling down the streaming-provider data comprises scaling down the streaming-provider data based on an estimate of what portion of the instances of streaming of the broadcast were a result of continuous play.
